(19) United States
(12) Patent Application Publication
(10) Pub. No.: US 2014/0214461 A1
(43) Pub. Date: Jul. 31, 2014

(54) INDEXING TRAVEL ACCOMMODATIONS IN A NETWORK ENVIRONMENT

(71) Applicant: priceline.com LLC, Norwark, CT (US)

(72) Inventors: MICHAEL DILIBERTO, New Canaan, CT (US); JOHN CAINE, Bridgeport, CT (US); CHRISTOPHER MURDOCK, Fairfield, CT (US); JOSHUA J. FRANCIA, Westport, CT (US); JIM JIANQUIANG CHEN, Danbury, CT (US); AMIT PODDAR, Stamford, CT (US); JAYADAS CHELUR, Mount Kisco, NY (US); JAMES M. ROZELL, ARLINGTON, TX (US); BERNARD A. PHILLIPS, FLOWER MOUND, TX (US)

(21) Appl. No.: 14/231,643

(22) Filed: Mar. 31, 2014

Related U.S. Application Data
(63) Continuation-in-part of application No. 12/911,828, filed on Oct. 26, 2010, now Pat. No. 8,688,490.
Application No. 12/911,828 is a continuation of application No. 10/613,204, filed on Jul. 3, 2003, now Pat. No. 7,848,945.

(51) Int. Cl. G06Q 50/12; G06Q 10/02

(52) U.S. Cl. CPC G06Q 50/12; G06Q 10/02
USPC 705/5

(57) ABSTRACT

A method for evaluating travel accommodations is provided that includes identifying a plurality of hotel properties and assigning a hotel marketability index score to one or more of the properties such that one or more of the properties may be ranked. The hotel marketability index score may be based on a selected one or more characteristics associated with one or more of the hotel properties, the characteristics including rate competitiveness, hotel availability, hotel location within a cluster location, and hotel quality within the cluster location.

### CROSS-REFERENCE TO RELATED APPLICATIONS; BENEFIT CLAIM

This application claims the benefit under 35 U.S.C. 120 as a Continuation-in-part of application Ser. No. 12/911,828, filed Oct. 26, 2010, which is a continuation of application Ser. No. 10/613,204, filed Jul. 3, 2003, now U.S. Pat. No. 7,848,945, the entire contents of which are hereby incorporated by reference for all purposes as if fully set forth herein. The applicant(s) hereby rescind any disclaimer of claim scope in the parent application(s) or the prosecution history thereof and advise the USPTO that the claims in this application may be broader than any claim in the parent application(s).

### FIELD OF THE INVENTION

This invention relates in general to travel management and, more particularly, to a system and method for indexing travel accommodations in a network environment.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Computers and networking architectures have had a dramatic effect on the travel industry. Travel accommodation systems that employ the use of digital communications may offer a number of capabilities and options to a given traveler or end user. Such options may include providing a potential lodging property based on a city that was selected by the end user. Such capabilities may include the ability to provide travel arrangements for a prolific number of end users. These features, which are provided by many current travel accommodation systems, have contributed to a significant augmentation in the number of end users that are afforded the opportunity to secure appropriate travel arrangements by accessing a network and/or using a computer or an electronic device.

As the consumer base continues to expand, so too do the demands and preferences of the travel industry's customers and clients. Additionally, the average traveler continues to develop in sophistication such that he/she may seek travel arrangements that are precise and that account for a number of activities or time constraints that may be associated with a given trip. In attempting to address the needs of today's traveler, it is important to maintain a minimal level of complexity for a given travel accommodation system, as an end user should be afforded the opportunity to identify and secure reasonable travel accommodations with nominal effort. In addition, securement of the targeted travel accommodations should be simple enough such that a salesperson is not necessarily involved in the process. Moreover, executing and confirming travel arrangements should be performed quickly and accurately, as timing is often critical to the booking process. Accordingly, the ability to effectively manage the needs and requirements of today's sophisticated traveler, while providing an architecture that may accommodate a number of users and that is simple to utilize, provides a significant challenge to market participants in the travel industry.

### SUMMARY

The appended claims may serve as a summary of the invention.

### BRIEF DESCRIPTION OF THE DRAWINGS

In the drawings:

FIG. 1 is a simplified block diagram of a travel accommodation system for indexing travel accommodations in a network environment in accordance with one embodiment of the present invention;

FIG. 2 is a simplified block diagram of an example city clustering process associated with the travel accommodation system;

FIG. 3 is a simplified block diagram of an example metric and index-building process associated with the travel accommodation system;

FIG. 4 is a simplified block diagram of an example index-weighting and normalized-scoring process associated with the travel accommodation system;

FIG. 5 is a simplified web-page illustration that shows an example operation, which offers a rate being provided within a cluster index, in accordance with one embodiment of the present invention;

FIG. 6 is a simplified web-page illustration that shows an example operation, which offers a hotel availability sampling, in accordance with one embodiment of the present invention;

FIG. 7 is a simplified web-page illustration that shows an example operation, which offers a relative star quality sampling, in accordance with one embodiment of the present invention;

FIG. 8A is a simplified web-page illustration that shows an example of weighting components into a single score within the travel accommodation system in accordance with one embodiment of the present invention; and

FIG. 8B is a simplified web-page illustration that shows an additional example of weighting components into a single score within the travel accommodation system in accordance with one embodiment of the present invention.

FIG. 9 is a simplified block diagram of an example process of generating a hotel display ranking that may be implemented using the system herein.

FIG. 10 illustrates an example data processing method that may be used to generate a ranked list, based upon HDR values as defined herein, for items such as hotels or other properties.

FIG. 11 is a block diagram of a computer system with which an embodiment may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Embodiments are described in the following sections: 1. Hotel Marketability Index; 2. Hotel Display Rank; 3. Implementation Example—Hardware Overview; 4. Extensions and Alternatives.

1. Hotel Marketability Index

From the foregoing, it may be appreciated by those skilled in the art that a need has arisen for an improved travel accommodation indexing-architecture that provides for enhanced flexibility by accounting for the diverse needs of a number of participating end users. In accordance with one embodiment of the present invention, a system and method for indexing travel accommodations in a network environment are provided that substantially eliminate or greatly reduce disadvantages and problems associated with conventional travel industry tools.

According to one embodiment of the present invention, there is provided a method for indexing travel accommodations in a network environment that includes identifying a plurality of hotel properties and assigning a hotel marketability index score to one or more of the properties such that one or more of the properties may be ranked. The hotel marketability index score may be based on a selected one or more characteristics associated with one or more of the hotel properties, the characteristics including rate competitiveness, hotel availability, hotel location within a cluster location, and hotel quality within the cluster location.

According to another embodiment of the present invention, there is provided a method for storing information about an end user that includes storing data associated with one or more travel characteristics of an end user in a profile. The profile may be coupled to a hotel marketability index element that is operable to identify a plurality of hotel properties and to assign a hotel marketability index score to one or more of the properties such that one or more of the properties may be ranked. The hotel marketability index score may be based on a selected one or more characteristics associated with one or more of the hotel properties, the characteristics including rate competitiveness, hotel availability, hotel location within a cluster location, and hotel quality within the cluster location.

Certain embodiments of the present invention may provide a number of technical advantages. For example, according to one embodiment of the present invention, a hotel marketability index element is provided that offers a consistent and an accurate scale to be used by an end user in evaluating a host of potential travel accommodations. The hotel marketability index element may suitably categorize a series of properties such that they may be ranked based on criteria selected by the end user and system parameters as selected by a system administrator. A series of scores may then be offered to the end user such that he may make an educated and price-conscious choice for lodging based on the scoring system. In one general sense, more information is being offered to an end user such that his travel accommodation decision is an informed one. The scoring system may preference properties based on a number of selected parameters that are processed by the hotel marketability index element.

Another technical advantage associated with one embodiment of the present invention relates to its flexibility. The results of various hotel marketability index components may be multiplied by weights and summed into a single score. One analysis of existing data may indicate that one factor (e.g. hotel availability) should have significant weight on the resultant score. Thus, particular important index components may be used to modify or affect the resultant score based on particular selections of the end user or particular circumstances associated with the targeted lodging pool. In certain cases, a system designer may choose to assign more weight to a given index component because of a particular event that may be occurring during the time frame associated with the lodging search. Other weighting processes may vary depending on the type of search made by an end user.

Yet another technical advantage associated with one embodiment of the present invention is a result of the accessibility of the hotel marketability index element. The hotel marketability index element may be used by a hosting entity in providing feedback information or consultations to a supplier: the information potentially relating to how to improve their hotel marketability index score. Thus, a hosting entity may communicate with existing properties or attract new properties by communicating weaknesses or strengths of their respective lodging (with regards to rates, availability and location), which may affect their potential ranking. Accordingly, hotel managers are better able to address deficiencies such that their overall score may improve, while simultaneously the consumer base is benefiting from the improvement to the lodgings and the greater attention being paid to problematic areas for the lodging that is being evaluated. Performance indicators may also be provided (e.g. via a monthly or semi-annual report) to participating hotel corporations and companies, the report reflecting how their properties are currently being displayed on the hotel marketability index system and/or how such entities can improve their screen placement.

Still another technical advantage associated with one embodiment of the present invention relates to an interface that may be utilized in order to interact with a consumer. An end user is provided an opportunity to set up a profile for himself (or others) and use the hotel marketability index process in addressing his specific lodging needs. In certain embodiments, coupons or reduced-price alerts could be generated to specific end users based on their preferences, or based on previously-selected lodging accommodations (potentially coupled with the likelihood that such consumers would be interested in the identified properties). Thus, automatic e-mails could be generated for consumers when a certain set of criteria, which may be provided by the end user, are matched in the system. End user profiles may be modified, updated, or otherwise changed in any suitable manner. Certain embodiments of the present invention may enjoy some, all, or none of these advantages. Other technical advantages may be readily apparent to one skilled in the art from the following figures, description, and claims.

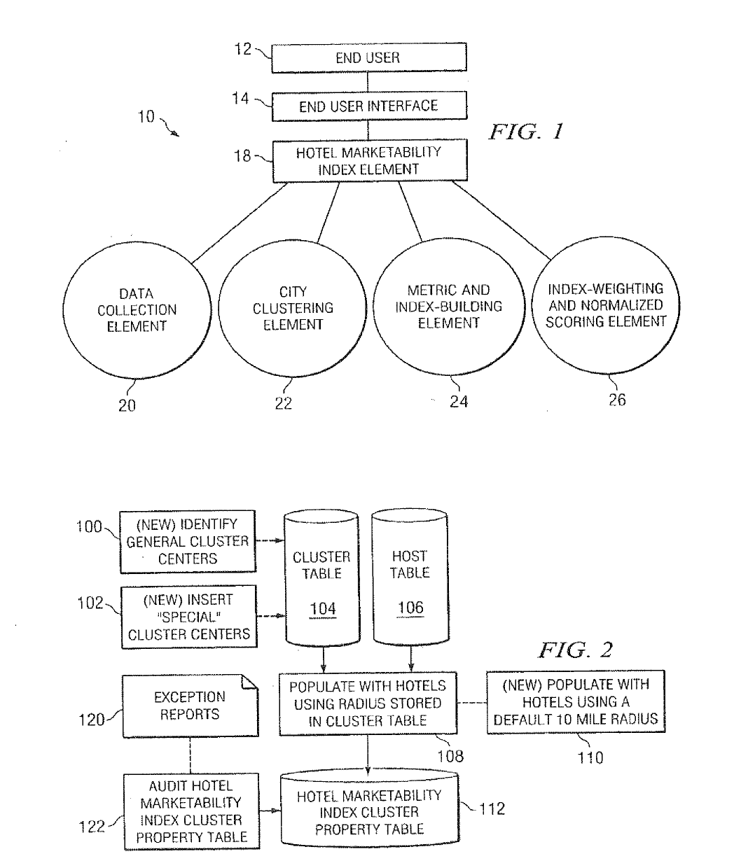

FIG. 1 is a simplified block diagram of a travel accommodation system 10 for indexing travel accommodations or properties in a network environment in accordance with one embodiment of the present invention. System 10 comprises an end user 12, an end user interface 14, and a hotel marketability index element 18. Additionally, system 10 comprises a series of elements that may be coupled to hotel marketability index element 18, including a data collection element 20, a city clustering element 22, a metric and index-building element 24, and an index-weighting and normalized-scoring element 26. One or more of the elements included within system 10 may be included in any suitable network environment or digital application. In addition, system 10 may be provided in conjunction with any appropriate travel accommodation tool or architecture such that end user 12 is provided with some ability to access hotel marketability index element 18 in an electronic, digital, or network environment.

In accordance with the teachings of the present invention, system 10 operates to provide an architecture capable of indexing a series of properties such that they may be ranked based on selected criteria and system parameters. The criteria may be designated by end user 12 and/or assigned by an administrator or a designer of hotel marketability index element 18. A default set of system values may also be provided. Hotel marketability index element 18 may execute a scoring process that preferences properties based on the likelihood of a sales conversion within a geographic region or cluster. Hotel properties may be clustered using latitude and longitude data associated with selected geographic areas. Hotel marketability index element 18 may collect data from a variety of sources such as, for example, data collection element 20 or city clustering element 22. The data may then be used in invoking metric and index-building element 24 and/or index-weighting and normalized-scoring element 26 in order to produce a resultant set of properties to be displayed to end user 12.

In order to create a hotel marketability index score, the results of the various hotel marketability index components may be multiplied by weights and summed into a single score. One analysis of existing data may indicate that two factors should have significant weight in the score: hotel availability and value to retail. Other weighting may vary depending on the type of search made by end user 12 or assignments of a system administrator. A number of parameters may be used as criteria in order to provide end user 12 with a suitable selection of travel accommodations. In one example embodiment, rate competitiveness, hotel availability, hotel location within the cluster (proximity), and hotel quality within the cluster (potentially star-based) are used. Rate competitiveness may be generally based on data collected from two primary sources: availability requests and automated shopping results. In one embodiment, the data may be used to build five measures of rate competitive indices: 1) rate within a cluster; 2) rate within star quality; 3) rate within a market; 4) rate on other competing sites; and 5) value to retail. Those elements may be processed in order to produce one component of an overall property score. Additional processes may be utilized in order to derive the other components that form a hotel marketability index score. Details relating to these additional components are provided below with reference to FIGS. 2-8B.

Hotel marketability index element 18 may be used to determine which hotels will be displayed to end user 12 and in what order the properties will be displayed when consumers search for appropriate accommodations. For example, a list of twenty to twenty-five hotels that match some or all of a specified criteria may be initially displayed in a hierarchical manner based on their index scores. It is intended that these displayed items will result in a converted sale by end user 12.

End user 12 is a client, a consumer, a prospective customer, or an entity wishing to access or to initiate a communication with hotel marketability index element 18. Alternatively, end user 12 may be any device or object that seeks to initiate a communication on behalf of another entity or element, such as a program, a database, or any other component, device, element, or object capable of initiating a data, script, or voice exchange within system 10. Data, as used herein in this document, refers to any type of numeric, voice, or script data, or any other suitable information in any appropriate format that may be communicated from one point to another. In an example embodiment, end user 12 is a traveler seeking suitable lodging, whereby information about the lodging pool is provided by hotel marketability index element 18. End user 12 may be seeking to review certain characteristics or parameters associated with a given set of properties such that he/she/it can choose optimal travel accommodations based on particular needs.

End user interface 14 is a central processing unit (CPU) in accordance with one embodiment of the present invention. End user interface 14 may be employed by end user 12 in order to initiate communications with any number of elements within system 10, such as hotel marketability index element 18, for example. Alternatively, end user interface 14 may be any other suitable interface that facilitates communications between end user 12 and any element within system 10, such as: a cellular telephone, a personal computer, an electronic notebook, a personal digital assistant (PDA), or any other suitable device (wireless or otherwise), component, element, or object capable of accessing one or more elements within system 10. End user interface 14 may also comprise any suitable interface for a human user such as a display, a microphone, a keyboard, or any other appropriate terminal equipment according to particular configurations and arrangements. In addition, end user interface 14 may be a unique element designed specifically for communications involving hotel marketability index element 18. Such an element may be fabricated or produced specifically for travel-inquiry applications involving end user 12 and other elements within system 10.

Note also that end user interface 14 may be utilized in order to interact with a consumer in other appropriate fashions. For example, end user 12 may set up a profile for himself (or others) and use the hotel marketability index process in addressing his specific needs. Such a personal profile may be stored in hotel marketability index element 18 or provided in any other suitable location external thereto. Additionally, coupons (inclusive of reduced-price alerts) may be generated for specific users and communicated electronically or via the standard mailing system. The coupons may be based on end-user preferences or based on previously selected accommodations and the likelihood that the identified properties would interest the receiving end user and/or result in a sales conversion. Thus, automatic e-mails could be generated by system 10 for consumers when a certain set of criteria are provided by end user 12 and matched in the system. Profiles may be modified, updated, or otherwise changed where appropriate and based on particular needs.

Hotel marketability index element 18 is a software element operable to provide one or more resultant properties to end user 12 based on selected criteria. In one embodiment, hotel marketability index element 18 cooperates with a web server (and may be coupled thereto or stored thereon where appropriate) in order to display one or more results obtained from a given set of parameters, as specified by end user 12 and/or as designated by a system administrator. Alternatively, hotel marketability index element 18 may include any suitable hardware, processors, algorithms, modules, components, devices, objects, or elements (or any suitable combinations of these elements) operable to effectuate the operations thereof. In addition, hotel marketability index element 18 may include any of the other elements illustrated in FIG. 1 within its internal structure where appropriate. Their representation in FIG. 1 is offered for purposes of example and clarity only. System 10 enjoys considerable flexibility in that any of these elements may be provided in any other suitable location or combined where appropriate and in accordance with particular configuration needs. For example, hotel marketability index element 18 may include both a web server and a processor that are (collectively) operable to collect data and provide a given resultant set of properties based on that information to an interested end user.

The hotel marketability index scores may be the primary factors for the display on a given website (e.g. Travelweb.com). A given web sever may process properties using the descending order of the hotel marketability index scores stored on the server and provided by hotel marketability index element 18. Each property may then be checked for availability and displayed in the order it was processed. Higher scoring properties may receive a screen placement preference over lower scoring properties.

Data collection element 20 is a segment, node, or location within system 10 that may be used to store information or data associated with selected properties or locations that may be sought to be identified and/or evaluated by end user 12. Data collection element 20 may include software operable to provide an interface for communications involving hotel marketability index element 18. Alternatively, data collection element 20 may include any suitable hardware, algorithms, modules, components, objects, or elements operable to facilitate communications between itself and any other element included within system 10.

The data retrieved from external sources and stored in data collection element 20 (or alternatively in city clustering element 22) may be categorized as either property detail data or property performance data. With respect to the former, property detail data reflects information relating to the location or attributes of a specific hotel. The data may be collected in any suitable fashion, and properly stored in an appropriate storage location, for example, in a database included external to system 10 or provided internally within any of the elements of system 10. The database may be modified, audited, scrubbed, or periodically updated in any suitable manner based on particular needs. The specific hotel data may include property information, location information, amenity information, quality information, and/or any other suitable information associated with a given property.

With respect to the latter, property detail is associated with information about the property at a general level. Such information may include a property name, a chain code, ownership information, a hotel phone number, a hotel fax number, and/or a hotel e-mail address. In addition, such information may include personnel data such as, for example, revenue managers, reservations managers, or regional contacts.

Location information that is stored in data collection element 20 (or city clustering element 22) may provide a significant data driver in the hotel marketability index process. The location information may reflect the physical address of the property, including more specific information such as a corresponding street address, as well as city, state, postal code, and country information. Other information details may include the latitude and longitude of the property. Using the latitude and longitude of the property, city or area clusters may be generated or constructed in order to form geographic centers. Additional details relating to the cluster-building process are provided below with reference to FIG. 2.

Amenity information may be used by hotel marketability index element 18 and stored within data collection element 20 (or city clustering element 22). Dynamic scoring may be performed in response to consumers selecting hotels with certain amenities. For example, if a consumer searches for properties with a high-speed Internet connection, scoring operations could be rerun based only on those properties that meet this criteria.

Quality information in the hotel industry may be generally referred to as a “star rating.” Star ratings may range between zero and five stars (five stars being an optimal score) and may be acquired from a variety of sources. For example, star ratings may be retrieved from the American Automobile Association (AAA) or from the Mobil Corporation. Additional sources may include Froemmer's, Conde Nast Publications, or the “Hotel Travel Index,” each of which may provide consumers with estimates of a hotel's quality. Star ratings may also be provided based on consumer feedback obtained from a given entity.

Property performance data may be generally collected from internal sources. For example, two primary sources may be the log data from all lodging transactions and shopping data collected from another suitable location (e.g. tracking via Travelaxe software). With respect to the transaction log data, such information may reflect the time and the result of every availability request made from a given entity (e.g. the Pegasus Corporation) via a corresponding given server. When consumers perform hotel searches on any given website (or through affiliates of the operator of the website), the system may log the result of that request. This data may be referred to as availability data.

For requests that return rates, the log data may include the time of the transaction, the affiliate performing the transaction, the chain code and property identification of the requested hotel, the corresponding rates, the room types, the rate types, the check in/check out dates requested, the response time of the transaction, and any other suitable information associated with the request. Requests that fail to return rates may include the chain code and property identification, the error code indicating why the request returned no rates, and the consumer input information on the request (e.g. check in date, check out date, etc.).

A more specific type of log data may also be acquired using a direct access method. For this method, a listing of hotels with applicable check in and check out data may be communicated directly to an entity via a suitable proprietary gateway. The requests may return the same information as the normal entity logs, but may also return the non-merchant rates with the results. Such a process is not necessarily consumer driven. Instead, the process reflects a forced availability call generated by a given company.

Competitive shopping detail may be acquired using appropriate software (e.g. Travelaxe software). The software may perform a substantially simultaneous comparison of competing hotel sites and, further, collect rates for specific properties based on check in and check out dates. The software may also provide the hotel marketability index process with an average nightly rate and all applicable taxes and fees for booking on other competing travel websites. The data may be output and properly stored (locally in certain embodiments) in corresponding databases.

City clustering element 22 is a segment, node, or location within system 10 that may be used to store information or data associated with selected properties or locations that are sought to be identified and/or evaluated by end user 12. City clustering element 22 may include software operable to provide an interface for communications involving hotel marketability index element 18. Alternatively, city clustering element 22 may include any suitable hardware, modules, algorithms, components, objects, or elements operable to facilitate communications between itself and any other element included within system 10. In addition, city clustering element 22 may be provided within hotel marketability index element 18 or combined with any other element provided within system 10 where appropriate. In order to explain some of the details and operations associated with city clustering element 22, reference is made to FIG. 2.

FIG. 2 is a simplified block diagram of an example city clustering process associated with a travel accommodation operation to be performed in system 10. The city clustering process of FIG. 2 illustrates a cluster table 104, a hotel table 106, and a hotel marketability index cluster table 112. Cluster table 104 and hotel table 106 may be coupled to a hotel marketability index cluster property table 112 directly or via any suitable interface. These elements may interface with each other in order to properly identify, store, and (potentially) display a given set of clusters to be reviewed or evaluated by end user 12. A number of steps may be performed that implicate the corresponding elements such that a resultant set of clusters are generated.

The city clustering process may begin at steps 100 and 102, where cluster centers may be identified and where special cluster centers may be inserted into cluster table 104. During an initial execution of the city clustering process, all properties may be treated as new properties. The process may identify all of the physical cities contained within hotel table 106 and use suitable mapping software (for example Microsoft Mapoint) to specify a city center for that city. Unique occurrences associated with a city and/or its center may then be formulated or processed as clusters. Additionally, specific cities or areas may be assigned overrides for their city center. The overrides may be reflected by a set of exception reports 120 that are provided in the context of auditing hotel marketability index cluster property table 112 at step 122. For example, geographically, the city center of New York City might be at Location A, but from a consumer point of view the actual city center is at Location B. Thus, Location B may be identified as the true city center and the latitude and longitude values for the override city center may be added to hotel marketability index cluster property table 112.

In operation, cluster table element 104 and hotel table element 106 may store information provided by the operations performed in steps 100 and 102. By using the latitude and longitude values stored with each specific property, hotels may be assigned the cluster identification of any cluster where their latitude and longitude value is within the mileage threshold of the cluster center. For example, for certain clusters, if the city center is in Location A, then any hotel within ten miles (which may be provided as the default threshold as illustrated by step 110) of Location A may be assigned to that particular cluster. Thus, hotels may be populated using a given radius as stored in hotel marketability index cluster property table 112, as illustrated by step 108. Other clusters may have a threshold of two miles for densely populated areas or more than ten miles for sparsely populated areas. All deviations from the default threshold may be determined by an individual analysis of the original processing. Such decisions may be executed by a consumer or selected by a system administrator.

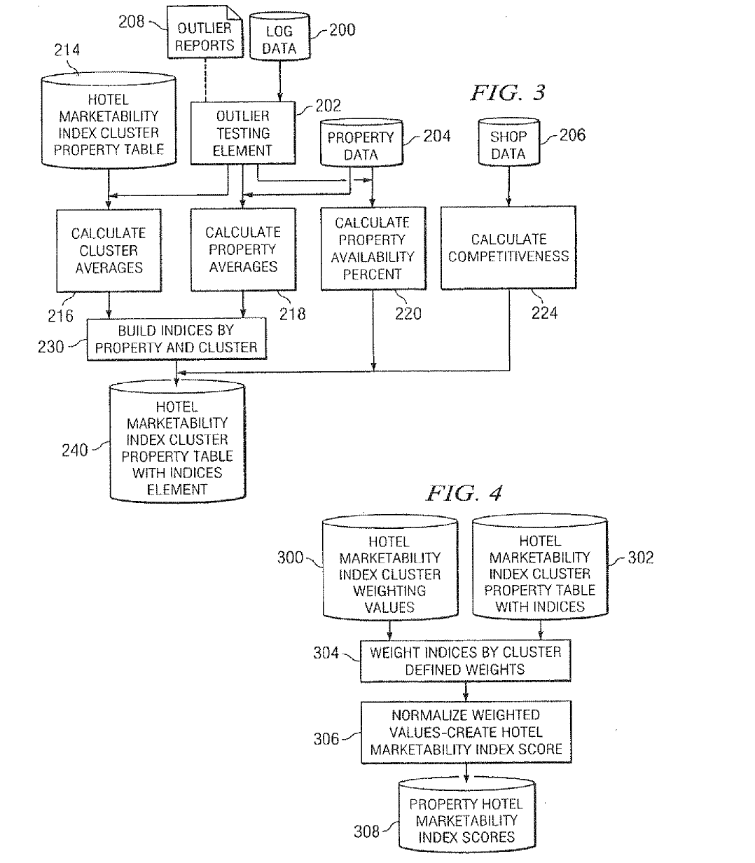

FIG. 3 is a simplified block diagram of an example metric and index-building process associated with system 10. The architecture of FIG. 3 may be used in order to provide a more accurate resultant set of properties identified by hotel marketability index element 18 by removing or accounting for information that skews data or misrepresents true property characteristics. FIG. 3 may include log data 200, property data 204, shop data 206, and a hotel marketability cluster property table 214. Prior to any processing of averages and indices, outlier data may be removed based on a set of outlier reports 208 that are communicated to an outlier testing element 202, which also receives portions of log data 200.

Outlier data reflects abnormal information that may be a result of (for example) certain hotels providing extremely high rates for particular properties, whereby the irregular information skews their averages. For example, property rates in the $10,000 plus range may dramatically affect a given set of properties of a selected corporate entity. In order to provide a more pure average, an outlier process may be executed that eliminates data more than three standard deviations from the normal output value for all given inputs. An exception to this process might be associated with the availability percentage, where no modifying of data is performed. Such decisions may be executed by a consumer or selected by a system administrator.

A next step in the metric and index-building process may be to create a set of averages within each cluster, from which indices may be built. For example, the following averages may be maintained using all hotels within a given cluster: average nightly rate within a general cluster, average nightly rate within a specific cluster, average nightly rate within a cluster and quality, average hotel quality within a cluster, and average distance from a cluster center. Other specific measures for each hotel, within a cluster, may also be collected. These measures may include: property average nightly rate within a general cluster, property average nightly rate within a specific cluster, property average nightly rate within a cluster and quality, property average hotel quality within a cluster, property average distance from a cluster center, property availability percentage by check in and check out date, property merchant rate to retail rate discount (value to retail), and property competing site competitiveness score. One or more of these elements may be compared against averages to create indices. Thus, outlier testing element 202 may communicate resultant data, along with hotel marketability index cluster property table 214, in order to calculate cluster averages at step 216.

Similarly, outlier testing data may be used in conjunction with property data 204 in order to calculate property averages at step 218. In addition, outlier testing data may be used in conjunction with property data 204 in order to calculate a property availability percentage at step 220. Step 216 may be used in conjunction with step 218 in order to build indices by property and cluster at step 230. Additionally, shop data 206 may be used in order to calculate competitiveness at step 224, which may be provided in conjunction with the resultant of step 220 to hotel marketability index cluster property table with indices element 240. Hotel marketability index cluster property table with indices element 240 may also receive suitable data from step 230, which builds indices by property and cluster.

Individual property information may be indexed against the average for the given cluster. This may result in a series of comparative indices for each property in each of the categories, as described supra. Indices may then be created for the following: rate within a general cluster, rate within a specific cluster (which may only be performed for those hotels that appear in specialty clusters, e.g. the Financial District in New York), rate within cluster and quality, quality within a cluster, and a distance within a cluster.

The remaining indices may be generated using individual property information. For example, an index may be generated reflecting the availability percentage by check in and check out date, which represents the number of requests that returned an available rate divided by the total number of requests for a specific check in and check out date. In addition, an index may be generated that reflects a value to retail figure, which represents a comparison of the property's lowest merchant rate to its lowest retail value in order to produce a percent discount off retail value. For example, if the lowest merchant rate is $90 and the lowest retail rate is $100, then the VTR (Value to Retail) is 90/100 or a 0.90. An index may also be created that reflects a property competing site competitiveness score, which provides a calculation representing a “win and loss” percentage against competing sites based on a variety of trials that are executed. A property may earn credit for a “win” when they post a rate no more than $3 higher than that which is available for the same accommodations on a competing site (e.g. Expedia or Hotels.com). A “loss” may be credited when a given property offers a better rate (by $3) on competing sites.

FIG. 4 is a simplified block diagram of an example index-weighting and normalized-scoring process associated with system 10. FIG. 4 may include a hotel marketability index cluster property table with indices element 302, which may be combined with hotel marketability index-weighting values 300 to be used at step 304 to produce weight indices by cluster defined weight. Weighted values may be normalized at step 306 in order to create a hotel marketability index score. Step 308 reflects the appropriate storage of property hotel marketability index scores for a number of properties. These scores may be displayed to end user 12 based on a given search or inquiry.

The final step of the process of FIG. 4 applies the weights that were defined to each cluster against the indices created form the data. Weights may be defined individually using specific characteristics of each cluster. For example, such characteristics may include: the radius of the cluster, higher proximity weight for larger geographic areas, quality of hotels in cluster, higher weights if area has a wider range of hotel quality, regional price sensitivity, economic factors affecting an area or any other suitable information. Weights may be applied to the indices and a score may then be generated. The scores may be normalized so that properties with an index of one (completely average) receive a mid-point of the weight. For example, if the weight of the star quality is worth thirty points, a completely average property (an index of one) would receive a fifteen added to their score. A higher quality hotel (an index of two) may receive twenty-five or thirty points, but no more than thirty points in one example scenario.

Once all of the weights have been applied and normalized, the total scores may be summed into a final score. Bonus points may then be added for properties with addresses in the city limits of the search (e.g., add ten points for a property located in Dallas, Tex. when a Dallas search is being performed, but do not add ten points for being in Irving, Tex. for such a search). Additional bonus points may be added for properties associated with a contractual engagement with a given entity. A final adjustment may allow a given entity to preference its own properties over retail properties.

In operation of an example embodiment, which is provided for purposes of teaching only, hotel marketability index element 18 may execute a scoring procedure that preferences properties based on the likelihood of a sales conversion within a geographic region or cluster. Hotel properties may be clustered using latitude and longitude data associated with geographic areas. In one example, a twenty-five mile radius from a city center or point of interest may be used. The radius may shrink/grow based on the density of properties within a target area. Each geographic area may result in a cluster of hotels that compete against each other for business. From the “city center” a circle may be drawn that encompasses a twenty-five mile spacing in each direction in order to build a base for the cluster. Each cluster may then be populated with a suitable number (e.g. one-hundred) hotel properties. The property threshold can be either increased or decreased for any given cluster based on particular needs. Sub-clusters can be created for larger metropolitan areas using more precise definitions where appropriate.

Any suitable number of parameters may be used as criteria in order to provide end user 12 with a suitable selection of travel accommodation characteristics. In one example embodiment, rate competitiveness, hotel availability, hotel location within the cluster (proximity), and hotel quality within the cluster (potentially star-based) are used and may be provided as options to be approved or disregarded by end user 12 (e.g. using a web-page accessed via the Internet). Other parameters, as described herein, may be implemented by end user 12 or a system administrator to narrow the corresponding search. A set of lodging properties that match the criteria provided by end user 12 may be returned and suitably displayed. End user 12 may then consummate the sale by providing a credit card or by suitably debiting his account. End user 12 may also finalize a property sale in any other suitable manner where appropriate and based on particular needs.

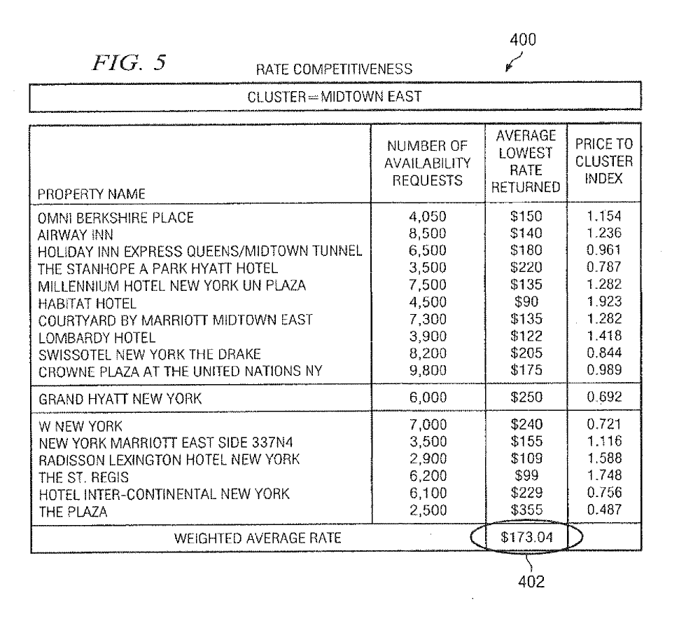

FIGS. 5 through 8B are provided in order to illustrate some potential operations to be performed within system 10. It is critical to note that these arrangements and configurations are offered for purposes of example and teaching only and, accordingly, should not be construed in any way to limit the scope or applications of system 10. System 10 enjoys considerable flexibility in that in may be implemented in conjunction with any suitable architecture and cooperate with any system parameters in order to achieve an optimal platform from which end user 12 may be provided with information associated with travel accommodations.

FIG. 5 is a simplified web-page illustration 400 that shows an example operation, offering a rate being provided within a cluster index in accordance with one embodiment of the present invention. The illustration of FIG. 5 references the Midtown East cluster of New York City, N.Y. and shows four segments, including a property name column, a number (#) of availability requests column, an average lowest rate returned column, and a price to cluster index column. For the set of properties within a cluster (provided in the first column of FIG. 5), a weighted average rate is derived from all availability requests. Each individual property's average rate may then be compared to the weighted average rate for the cluster. A rate within a cluster index is then created. In addition, a weighted average rate 402 may be displayed that is based on the cluster that was sampled.

In the context of a rate within a star quality index, properties with the same star rating may be used to derive the weighted average rate. With respect to the rate within a market index, a cluster may be expanded to the general area and a second index may be created. Note that this may apply in scenarios where the metropolitan area is large enough to create sub-clusters. In order to account for a value metric, a value to retail index may also be created. Using shopping data acquired via any suitable source (e.g. Travelaxe software) the competitive “win-loss percentage” may then be derived. A given rate associated with one entity (e.g. Travelweb.com) may be compared independently against other entities (e.g. Expedia and Hotels.com) for a variety of dates.

As described supra, wins may then be achieved where Travelweb.com has the selected rate and the competing entity does not or in cases where Travelweb.com and the competing entity both have rates and the Travelweb.com rate is no more than $3 higher than the competing rate. Losses may be recorded where the competing entity has a selected rate and Travelweb.com does not, or where the competing entity and Travelweb.com both have rates and the Travelweb.com rate exceeds the competing entity by more than $3. If a given property has three instances of wins and one instance of a loss, the property may be given a 75% competitive score.

Hotel availability may represent a significant component of the hotel marketability index process. All availability requests for a previous week may be considered when deriving the hotel marketability index scores. A significant weight may also be placed on the previous day. Hotel availability may be calculated on a check-in and length-of-stay basis. For example, a property may have different availability percentages for a check-in on April-20 for two days than it does for a check in on April-20 for one day. In instances where the check-in or length of stay patterns are unavailable, a weighted average availability percentage may be derived using a prescribed average pattern.

Check-in dates beyond thirty days may be summed into more general categories, for example: thirty-one to sixty days, sixty-one to ninety days, or ninety-one to one-hundred twenty days. In situations where distributors cannot apply (or choose not to apply) availability at the lower “check-in/length of stay” level, the data can also be used in the context of the weighted-average approach.

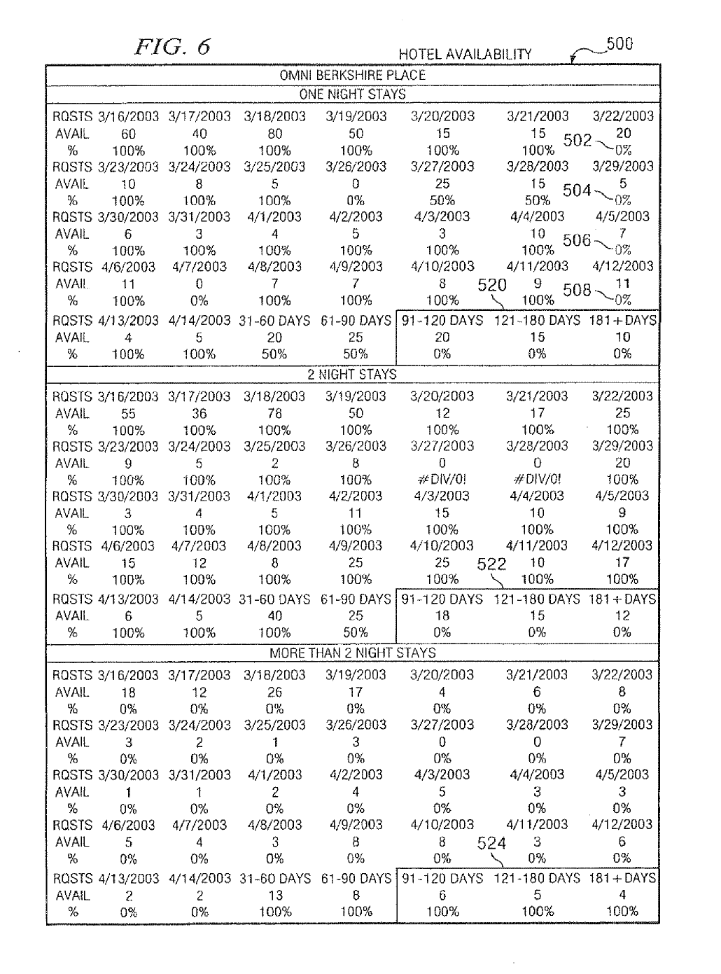

FIG. 6 is a simplified web-page illustration 500 that shows an example operation that offers a hotel availability sampling in accordance with one embodiment of the present invention. The hotel availability component of system 10 is offered in order to emphasize the importance of having a suitable number of vacancies to accommodate a given traveler who seeks appropriate lodging. Segments 502, 504, 506, and 508 illustrate that there is no Saturday check in available (0%) in March and April for the Omni Berkshire Place property. In addition, segments 520, 522, and 524 illustrate that dates that are at times further in the future only have availability for stays that are more than two nights. Thus, no availability exists for two-night stays (or less) for time frames between ninety-one and one-hundred eighty-one days (plus) for this particular property (Omni Berkshire Place).

Hotel marketability index element 18 may use the hotel's geographic location as a component of its score. The distance from a city center for each hotel may be calculated. City centers may be available for each cluster. Thus, a single property could have several different proximities based on the area being searched. For example, The Waldorf Astoria, located at 301 Park Avenue, has the following proximities in the New York area: New York (General) 0.3 Miles, Midtown East 0.5 Miles, Midtown West 0.7 Miles, Lower East 1.7 Miles, Lower West 1.8 Miles, Upper East 0.4 Miles, Upper West 0.6 Miles, Financial District 3.8 Miles, Central Park South 0.5 Miles, Central Park West 1.5 Miles, and Brooklyn 19 Miles. There are approximately thirty other proximities beyond Brooklyn.

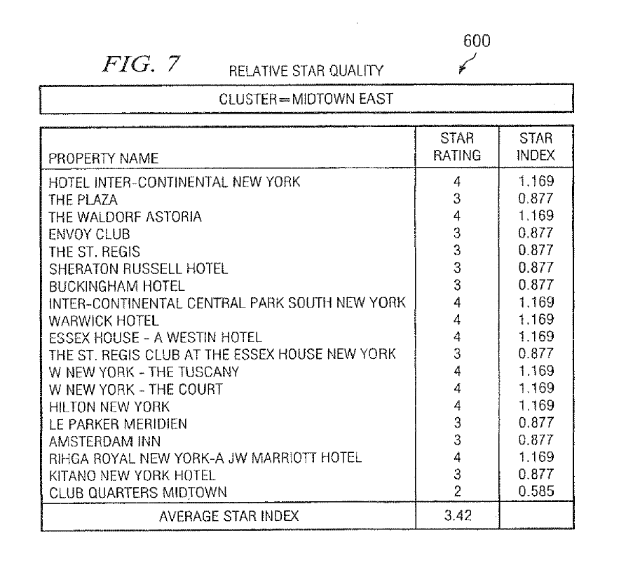

FIG. 7 is a simplified web-page illustration 600 that shows an example operation that offers a relative star quality sampling in accordance with one embodiment of the present invention. Similar to the various rate indices, a star quality index may be created by comparing each hotel's star rating to the average hotel star rating within the cluster. This may keep a two-star hotel (e.g. Club Quarters Midtown) that is located in the middle of ten four-star hotels from premier placement on the screen. In the example of FIG. 7, the average star index is provided as 3.42.

Thus, hotels may be compared to other hotels within their clusters based on the quality of the property. In order to estimate the quality associated with a given property, hotel marketability index element 18 may use the average star rating acquired from any suitable source. Such an operation may be reduced to a preferred rating service or a proprietary rating may be developed and implemented. Ratings that clearly deviate from the normal rating may be eliminated in calculating the average. For example, if AAA and Mobil rated a given property as a four-star location, and Expedia rated the same location with only one star, the Expedia rating may be eliminated.

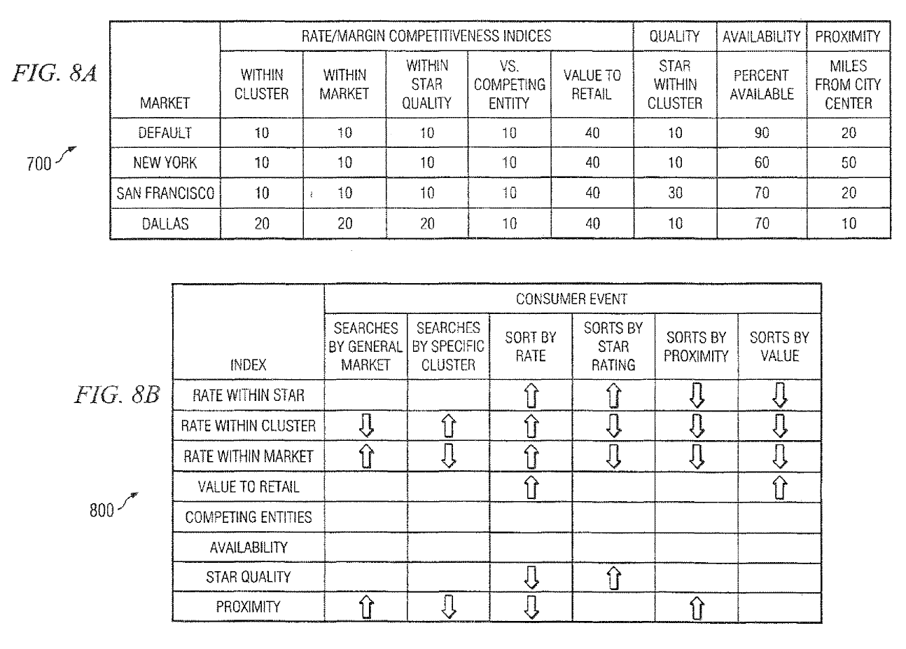

FIG. 8A is a simplified web-page illustration 700 that shows an example of weighting components into a single score within system 10 in accordance with one embodiment of the present invention. The components may be weighted on a two-hundred point basis and the weights may vary by cluster/market. For example, the proximity weight in New York City, N.Y. (where hotels are close to one another) is more significant than in Dallas, Tex. (where they are less dense). Additionally, the star within a cluster weight is more significant in San Francisco, Calif. where a four-star property may be on the same block as a two-star property. Note also that, as illustrated by FIG. 8A, a suitable set of default values may also be provided in such an arrangement based on particular lodging needs or designated travel characteristics.

FIG. 8B is a simplified web-page illustration 800 that shows an example of weighting components into a single score within the travel accommodation architecture of system 10 in accordance with one embodiment of the present invention. The weights designated may become even more influential when they are event-driven. FIG. 8B illustrates that two important factors, value to retail and availability, remain unchanged by a consumer event. Considerable flexibility is provided by hotel marketability index element 18 in that any characteristic or parameter may be used to affect or influence a selected lodging factor.

Hotel marketability index element 18 may also be used by a hosting entity in providing feedback information or consultations to a supplier or a property owner/manager (e.g. indicating ways that a supplier could improve their hotel marketability index score). Thus, system 10 provides an opportunity for an administrator or a sales representative to communicate with existing properties and attract new properties that may be used in offering an optimum number of choices to end user 12. The sales representative may be able to provide properties with relative performance indicators regarding how they are being displayed on the screen and how they can improve screen placement. Lodging characteristics of a given entity may be stored in an entity profile. The lodging characteristics may reflect any suitable information relating to locations associated with the entity such as, for example, data used to generate the hotel marketability index score. Other lodging characteristics could reflect market share values, recent sales trends, improvements or deficiencies in one or more of the properties owned by the entity, or any other suitable or germane information that may be of interest to the entity.

Any administrator or sales representative associated with the hosting entity of system 10 may also be able to demonstrate to new/potential properties how the hotel marketability index process can increase conversion figures and reduce time-intensive record-keeping (i.e. looks-to-books, as it is commonly referred to in the travel industry). An administrator may also be able to readily identify poor performing hotels and utilize a tool that offers solutions or suggested improvements to performance problems with the use of quantitative data.

In operation of an example embodiment, managers of existing or new properties may access information provided by hotel marketability index element 18 via any suitable user interface, or simply log-on through their corporate account in order to determine how they can improve their score or enhance the value that is being offered to the customer. The information provided may offer an opportunity for suppliers to pinpoint areas of weakness. For example, a supplier may see that their star quality is suffering dramatically and, accordingly, address that area in order to improve their index score. A hosting entity associated with hotel marketability index element 18 may also provide properties with relative performance documentation or reports (e.g. via monthly reporting) regarding how the properties are being displayed on a corresponding web-site. Poor-performing hotels may also be identified and be provided with an accurate and a consistent measurement tool (hotel marketability index scores) that allows such hotels to change their strategy or enhance elements of their business practice that are contributing to weaknesses in their hotel marketability index score. In egregious cases, poor-performing hotels that fail to improve may be de-listed from a database within hotel marketability index element 18 such that they are not displayed to end user 12 for a potential sale.

As described above, the elements and operations represented in FIGS. 2-8B may be effectuated within the architecture of system 10. FIG. 1 generally represents just one electronic environment or network configuration for one or more of the elements within FIGS. 2-8B to utilize in performing one or more of their operations. Accordingly, alternative communications capabilities, data processing features, infrastructure, and any other appropriate software, hardware, or data storage objects may be included within FIG. 1 to effectuate the tasks and operations of the elements and activities associated with any of the embodiments of FIGS. 2-8B. For example, hotel marketability index element 18 may be utilized in conjunction with a cellular telephone via a wireless local area network (WLAN) in order to secure adequate travel accommodations. Additionally, hotel marketability index element 18 may be provided as a software package to be sold to any individual interested in being able to perform such searching capabilities. A purchasing consumer may receive periodic updates from an administrative entity such that the most current data associated with relevant lodgings is provided to the individual. FIG. 1 provides just one of a myriad of suitable processing or communication platforms from which system 10 may operate.

Although the present invention has been described in detail with reference to particular embodiments in FIGS. 1-8B, it should be understood that various other changes, substitutions, and alterations may be made thereto without departing from the spirit and scope of the present invention. For example, although the present invention has been described as operating in a hotel accommodation environment, any suitable business endeavor may benefit from the teachings of the present invention. For example, a rental-car company may use system 10, whereby a series of indices are provided in order to direct or control a marketability index score. The score could be based on similar components (as identified herein) or use other suitable parameters for evaluating a given set of travel accommodations. Similarly, various other suitable business structures or reservation-based operations that seek to secure suitable accommodations may benefit from the teachings of system 10.

Additionally, it should be noted that although the example embodiments have described certain steps or operations to be performed, these operations and processes may be modified considerably without departing from the teachings of the present invention. In addition, other steps may added and selected steps may be deleted: such changes being the result of particular system configurations, specific architectural arrangements, or designated parameters. These modifications are within the scope of system 10 and may be based on particular operational needs.

Numerous other changes, substitutions, variations, alterations, and modifications may be ascertained to one skilled in the art and it is intended that the present invention encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this invention in any way that is not otherwise reflected in the appended claims.

2. Hotel Display Ranking

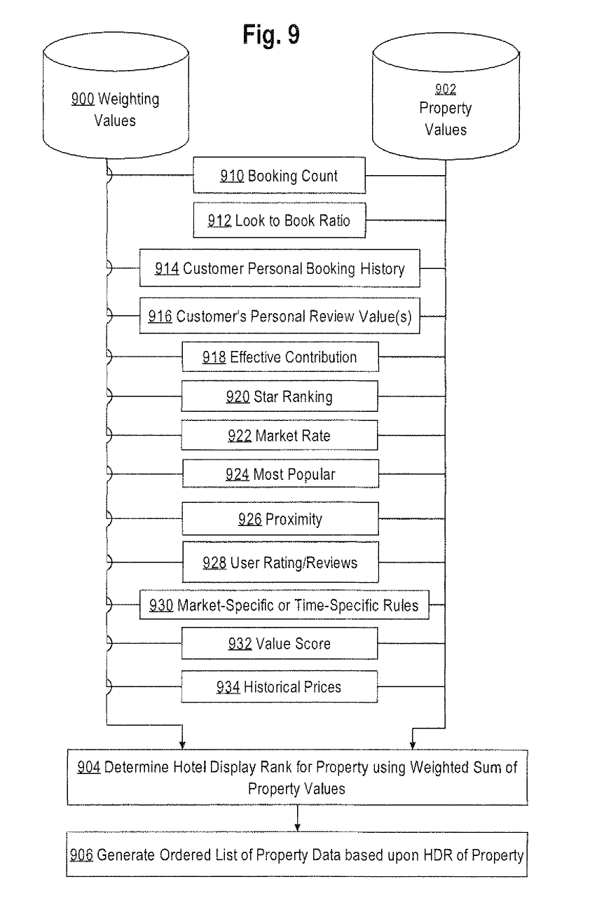

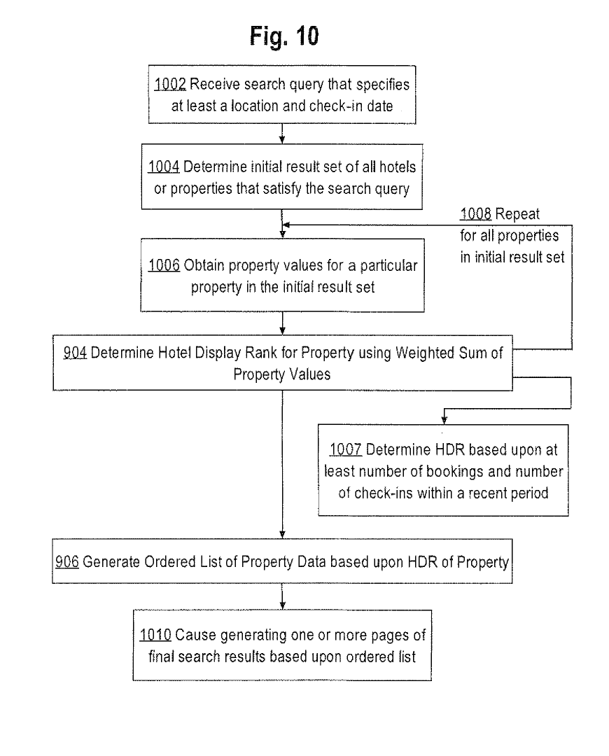

In an embodiment, the system previously described may be configured to generate a hotel display ranking (HDR) score value for each of a plurality of hotels or other properties and for use in ordering the hotels or other properties in search results or other displays that are generated as part of an interactive online booking system. For purposes of illustrating clear examples, FIG. 9 and FIG. 10 are described herein in the context of data relating to hotels, motels, resorts and similar properties that are capable of booking for a period of time and that are associated with specified check-in dates, locations, and rates or prices. However, the functions described herein may be used in other embodiments for ranking lists of items other than hotels based upon other attributes; examples include rental movies or TV shows, automobiles for sale, restaurant tables, and in general any item that is capable of an initial view and/or booking or reservation that is separated at least slightly in time from a later check-in, purchase or use.

FIG. 9 is a simplified block diagram of an example process of generating a hotel display ranking that may be implemented using system 10. In arrangement similar to that of FIG. 4, FIG. 9 may include a first data store 902 of property values, which may be combined with a second data store of weighting values 900 to result in determining, at block 904, a hotel display rank for a property using a weighted sum of the property values for a particular property. At block 906, the resulting total hotel display ranking score may be used to generate an ordered list of property data based upon the HDR score of each property. For example, a set of search results identifying a plurality of different hotels or other properties may be displayed to end user 12 based on a given search or inquiry in order of descending value of HDR, so that properties with the highest total HDR score are listed first. Logic to implement FIG. 9, and the determinations and calculations described in this section, may be integrated into element 18 of system 10 of FIG. 1, for example, or may substitute for the logic of FIG. 3.

In an embodiment, property values 902 comprise a plurality of different counts, ratios, scores and other values derived from the attributes specified in FIG. 9. In one embodiment, property values 902 are used to generate a total HDR score based at least upon the number of recent bookings and the number of recent actual check-ins by guests. For example, recent bookings may be indicated by a total count of actual bookings made through the system 10 within the last 30 days, and check-ins may be counted within the last 30 days or in the future. In an embodiment, the higher number of bookings for a property within this time frame the higher the hotel is ranked and subsequently displayed. In addition, in some embodiments, the property values 902 may be configured to conform to one or more contractual obligations between owners or operators of hotels or other properties and an owner or operator of the system 10, such as guarantees about when certain hotels or brands must be displayed.

In another embodiment, property values 902 are used to generate a total HDR score based at least upon the number of recent bookings, the number of recent actual check-ins by guests, and based upon a look to book ratio.

In an embodiment, a total HDR score, alternatively termed a property effective score, may be determined based upon the expression

HDR Total Score=(V₁)*(C₁)+(V₂)*(C₂)+ . . . (Vₙ)*(Cₙ)

where V denotes a variable and C denotes a coefficient or weighting value. In an embodiment, values of V are stored in a database in association with information identifying each hotel or property that is managed using the system 10, and values of C are stored in a separate table or mapping of the coefficients to variable names. The particular schema or data structures that are used to store or manage values of V for properties and values of C are not critical; what is important is that values of C may be modified, managed or tuned independently of the values for V that are collected for each property. In this manner, the system 10 is adjustable to address different business goals or desired outcomes in ranking, displaying or marketing hotels or other properties. For example, there may be a need over time to increase a weight value C₁ associated with a particular variable Vi while decreasing C₂ for V₂.

In one embodiment, as seen in FIG. 9, the variables V comprise booking count 910, look to book ratio 912, customer personal booking history 914, customer personal review values 916, effective contribution 918, star ranking 920, market rate 922, most popular 924, proximity 926, overall user rating or review values 928, market-specific or time-specific rules 930, value score 932, and historical prices 934. Values for each of the foregoing variables are determined over time for each of the properties managed in the system 10; thus, each of the foregoing variables is intended to reflect a count, ratio, score or other value for a particular hotel or property.

In one embodiment, booking count 910 is a count of the total number of actual bookings of the associated hotel or other property based upon a specified period, such as 30 days, 3 months, 6 months, 1 year, etc. Any suitable period may be used, and may be stored statically or as a configurable value. Data for booking count 910 may be obtained from other parts of system 10 that are configured to accept actual bookings of hotels or other properties alone or in communication with booking systems of the hotels, properties, and/or their brands or owners or operators.

In one embodiment, look to book ratio 912 comprises a metric generally indicating the importance of a property based upon how past users have viewed data relating to the property (“looks”) in comparison to the number of times that other users have booked a stay at the property (“books”). Data representing looks may be compiled in various ways. In one approach, a look is based upon the position of data representing the property in search results provided in response to previous queries of other users, and whether other users have viewed the details page for the property. For example, the system 10 may be configured to compute looks based upon a property listing's page number in search results, such as whether property is displayed on page 1, 2, 3, etc. of search results; position on the page, such as whether the listing has been previously displayed at the top or bottom or middle of the listing's page; and user selections or clicks to a details page for the hotel, property or listing may be given higher weighting. In one embodiment, looks are determined by computing the expression:

Effective look for a property in a given time period=SUM Of [(1L*Page-Number-coefficient/Page-number)+(1L*Page-Position-coefficient/Position-on-page)1/No-of-impressions+SUM Of [1D*detail-page-coefficient]/No-of-detail-page-clicks

where 1L denotes each impression on a listing page, and 1D denotes one click through to the detail page for the property. Page-Number-coefficient is a weight value that permits giving reduced weight, for example, to listings that appear on a high page number, that is, deep down in the search results of a prior query. Page-number is the number of the search results page on which the property appeared. Page-Position-coefficient is a weight value that permits giving reduced weight, for example, to listings that appear far down a page and greater weight to listings that appeared at the top of a page. Position-on-page is a metric indicating a relative position of a listing on a page of past search results, such as top, middle, bottom. No-of-impressions is the number of times that the property has appeared in search results. Detail-page-coefficient is a weight value that permits giving increased or decreased value to particular kinds of detail pages or particular detail pages for particular properties. No-of-detail-page-clicks is a number of times that users have selected one or more detail pages for a particular property.

In an embodiment, customer personal booking history 914 represents a match between preferences of a particular current user who is performing a search of hotels or properties and attributes or amenities of a particular hotel or property. For example, if the current user prefers a particular star rating, a particular geographic region or a particular price point based upon the user's pas actual bookings, then the value of a variable for customer personal booking history 914 will be higher for a particular property if attributes of that property match the user's past preferences. Consequently, if the user prefers a particular star rating, region or price point, then preference will be given to properties with these characteristics; further, if the user has shown a preference for a particular property, then that property will have a higher total HDR score after customer personal booking history 914 is included in the determination.

In an embodiment, customer personal review values 916 enable promoting or demoting a particular property in search results or other ordering based upon a particular user's past personal review of the property. In an embodiment, if a user has posted a negative past review of a particular property, then the customer personal review value 916 for that property is lower, and if the user has posted a positive past review of the particular property, then the customer personal review value for that property is higher.

In an embodiment, effective contribution 918 represents a business benefit of the associated property to a business associated with the system 10. For example, effective contribution 918 may reflect a relative level of margin or profit on bookings of the associated property that is earned by the system 10 when the property is booked. Effective contribution 918 may be computed as past contribution and potential contribution, based on current price and margin, relative to peer properties.

In an embodiment, star ranking 920 is a metric that reflects a star ranking of the associated property. For example, a four-star hotel may have a higher value for star ranking 920 than a two-star hotel.

In an embodiment, market rate 922 reflects a comparison of a current price of a particular property relative to its peers. In this context, peer properties may comprise properties with the same star rating in the same geographic region. In an embodiment, if the current price of a particular property is high relative to its peers, then the value for market rate 922 may be lower, whereas a lower market rate for the particular property may result in determining a higher value for market rate 922 to increase the ranking of the property.

In an embodiment, the value for most popular 924 reflects the relative position of the current property among the most popular properties based on particular combinations of attributes. In an embodiment, past buying patterns may be used to determine the most popular combination of various parameters such as price, star, amenities etc. for a given market, advance purchase (AP) and length of stay (LOS). For instance if system 10 has determined by analyzing past data that customers buying on Mondays in Dallas, TX for advance purchase of 2-3 days, with LOS from 2 to 4 days are looking for 3+ star properties in the price range of $165 to $200, which serve free breakfast, then the system 10 is configured to increase the value of the most popular 924 metric to cause properties satisfying the aforementioned pattern to appear higher in ranking. In an embodiment, patterns of attributes may be hard-coded, specified in configuration data, or specified in the data schema of the data repository, for example as lists of name-value pairs that must match attributes of the particular property to cause an increase in ranking.

In an embodiment, the value for proximity 926 indicates a relative distance of a particular property from a location that is the subject of a search of a current user. The value for proximity 926 may be computed dynamically in response to a user search query. For example, if a user specifies New York—Times Square as one search criteria, then system 10 may compute updated values for proximity 926 based upon computing a distance between New York—Times Square and the stored latitude-longitude values identifying locations of each of the properties. If the computed distance value for a particular property is large, then the value of proximity 926 is set to be small, and if the computed distance value for a particular property is close to the user's specified search criteria, then the value of the proximity 926 is set to be large. Thus, if the customer is looking for properties in a specific area or district of a large city, then computation of the HDR will cause sorting the properties based on the distance from the center of the area.

In an embodiment, overall user rating or review values 928 reflect ratings or reviews of all users of system 10 for a particular property. For example, if an aggregated average rating of a particular property based on multiple individual reviews contributed by different users is 7.5 on a scale of 1 to 8, then the value 928 for that property may be determined to be high. In contrast, if reviews of a particular property are predominantly negative, then the value 928 for that property may be determined to be low. Thus, the effect of value 928 for a particular property is to influence the sorting of properties based on reviews of all users.

In an embodiment, the market-specific or time-specific rules 930 enable influencing the ranking of particular properties based upon rules specific to market and time periods. As an example, assume that a hypothetical entertainment conglomerate named Delta Charlie Properties operates multiple hotels and resorts in the city of Foxtrot, Florida. A market-specific rule stored in the data repository of the system 10 may specify that any user search for a hotel in Foxtrot, Florida must include three (3) or more hotels of Delta Charlie Properties in the search results. Thus, system 10 may be configured to bias the HDR of the three (3) hotels upwardly whenever the search query specifies Foxtrot, Florida. Additionally or alternatively, a time-specific rule may reflect seasonal booking goals; for example, a time-specific rule may specify that any search for a hotel in Colorado for check-in during January must include at least one hotel that is attached to a ski resort, whereas other rules may specify that the same search for a Colorado hotel for check-in during June must include at least one property that is affiliated with a horse corral.

In an embodiment, the value score 932 comprises a metric that may be calculated using factors such as median price, contribution, reviews, past booking history, etc.; thus the value score represents a general sense of the value of a particular property to the system 10.

In an embodiment, historical prices 934 is used to determine best value properties based on their rate change history. For example, if the price to book a particular property suddenly drops relative to current prices of similar properties or its own historical price, then the value of the historical prices 934 metric may be increased to cause pushing the property up in ranked order and suggest to the customer that it is a smart deal.

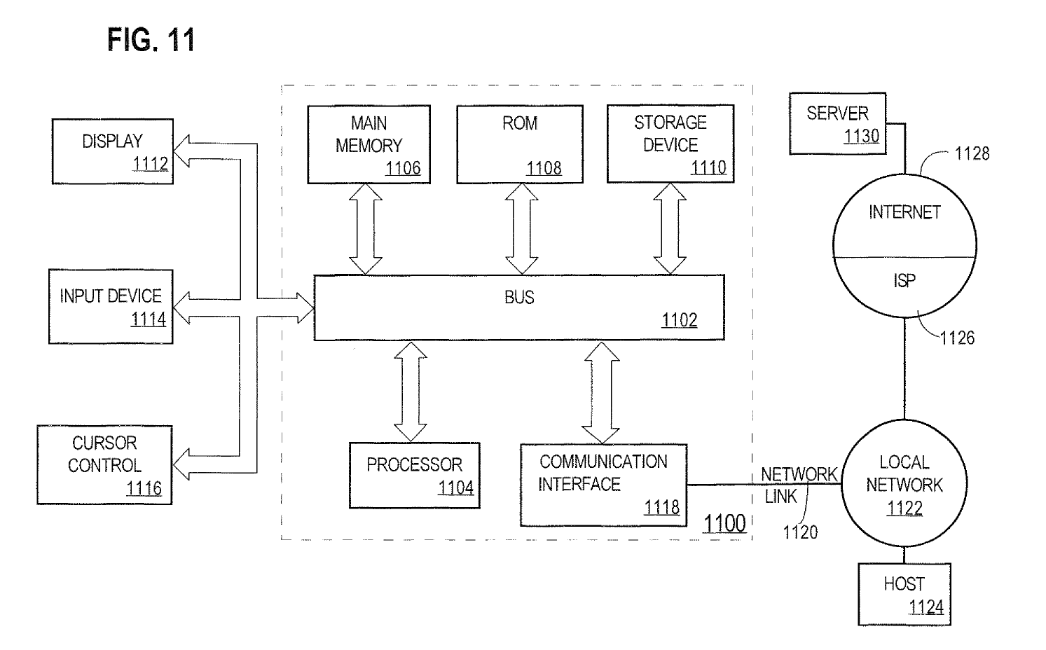

FIG. 10 illustrates an example data processing method that may be used to generate a ranked list, based upon HDR values as defined herein, for items such as hotels or other properties. In an embodiment, system 10 may implement the process of FIG. 10 using one or more computer programs, software elements or other functional logic that forms part of element 18 or element 24 (FIG. 1) or that is executed using a general-purpose computer of the type shown in FIG. 11 and coupled to the system 10 of FIG. 1. In one embodiment, the process of FIG. 10 is implemented in the context of an online hotel information, search and booking system, such as the PRICELINE.COM system that is commercially available from Priceline.com Incorporated, Norwalk, Connecticut.

At block 1002, the process receives a search query that specifies at least a location and, optionally, a check-in date. For example, the process receives data from a first computer associated with an end user or customer and representing a search for hotels in Times Square—New York for check-in on Oct. 8, 2014; this data may be received at a second computer acting as a server computer and that implements FIG. 10. The query may be received from an app hosted on the first computer in the form of a mobile computing device such as a smartphone or tablet computer, or from a browser hosted on the first computer in the form of a laptop computer, netbook, ultrabook, desktop computer or workstation. In an embodiment, the search query also may include other search attributes, such as a minimum star rating for hotels to be returned (e.g., 3 stars or more), amenities that the user wishes the properties to have (e.g., pool, free breakfast, etc.), and/or other attributes or values. Check-in dates may be omitted in embodiments and many search queries are expected to be received without dates.

At block 1004, the process determines an initial result set of all hotels or properties that satisfy the search query. Depending on the breadth of the search query and/or the number of attributes or values specified as part of the search query, the number of hotels in the initial result may be very large or very small. Logical rules may require relaxing the search query or ignoring certain narrowly specified attributes in order to specify a sufficiently large initial result set; for example, logical rules may specify that if the result set is fewer than 20 properties, one or more attributes or values in the query should be ignored until the result set reaches at least 20.

At block 1006, the process obtains property values for a particular property in the initial result set. Block 1006 may comprise retrieving, from stored data, values for each of the metrics of elements 910 to 934 inclusive shown in FIG. 9, or for a subset of them. Block 1006 also may include dynamically computing one or more of the metrics shown in FIG. 9. For example, value score 932, historical prices 934, market rate 922, and other values may be best computed by retrieving values of rates, prices, booking counts, reviews, and so forth at the time of a search query. Further, certain of elements 910 to 934 are necessarily dependent upon real-time data obtained at the time of a search query, such as proximity 926, the value of which cannot be determined until the user specifies a geographic focus of search.

At block 904, the process determines an HDR total score value for the particular property in the initial result set using a weighted sum of the property values that were developed using the process of FIG. 9. Alternatively, as seen in block 1007, the HDR may be determined based upon at least a number of bookings of the particular property and a number of check-ins to the particular property within a specified recent period. In other words, in the alternative of block 1007, at least the number of bookings and check-ins are used to compute the HDR of the particular property, and optionally one or more other metrics of FIG. 9 may be used.

As seen at arrow 1008, the operations of block 1006, block 904 are repeated for all properties in the initial result set.

At block 906, the process generates an ordered list of property data based upon the HDR of all properties. Thus, block 906 may involve sorting the initial result set based upon the HDR total score value of each property, or creating a new result set that is in sorted order by HDR total score value.

At block 1010, the process causes generating one or more pages of final search results based upon the ordered list. Typically the pages are electronically displayable pages such as pages of HTML output that can be displayed on the user computer. Thus, block 1010 may comprise, in one embodiment, dynamically generating an HTML document in an HTTP or JSON response to the user computer that contains a first page of the final search results and includes one or more hyperlinks that are configured, when selected, to cause retrieving successive pages of the final search results. Block 1010 broadly represents any useful presentation operation, such as generating a web page that contains final search results that are ordered based upon the total HDR score values, generating output in the form of XML, JSON blobs or other data representations for transmitting to and consumption by an app at a mobile computing device of a user, or other presentation operations. The particular form of presentation operation is not critical provided that it includes data for items such as hotels or other properties that are ranked or ordered based upon the total HDR score value that has been described.

3. Implementation Example—Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 11 is a block diagram that illustrates a computer system 1100 upon which an embodiment of the invention may be implemented. Computer system 1100 includes a bus 1102 or other communication mechanism for communicating information, and a hardware processor 1104 coupled with bus 1102 for processing information. Hardware processor 1104 may be, for example, a general purpose microprocessor.

Computer system 1100 also includes a main memory 1106, such as a random access memory (RAM) or other dynamic storage device, coupled to bus 1102 for storing information and instructions to be executed by processor 1104. Main memory 1106 also may be used for storing temporary variables or other intermediate information during execution of instructions to be executed by processor 1104. Such instructions, when stored in non-transitory storage media accessible to processor 1104, render computer system 1100 into a special-purpose machine that is customized to perform the operations specified in the instructions.

Computer system 1100 further includes a read only memory (ROM) 1108 or other static storage device coupled to bus 1102 for storing static information and instructions for processor 1104. A storage device 1110, such as a magnetic disk or optical disk, is provided and coupled to bus 1102 for storing information and instructions.

Computer system 1100 may be coupled via bus 1102 to a display 1112, such as a cathode ray tube (CRT), for displaying information to a computer user. An input device 1114, including alphanumeric and other keys, is coupled to bus 1102 for communicating information and command selections to processor 1104. Another type of user input device is cursor control 1116, such as a mouse, a trackball, or cursor direction keys for communicating direction information and command selections to processor 1104 and for controlling cursor movement on display 1112. This input device typically has two degrees of freedom in two axes, a first axis (e.g., x) and a second axis (e.g., y), that allows the device to specify positions in a plane.

Computer system 1100 may implement the techniques described herein using customized hard-wired logic, one or more ASICs or FPGAs, firmware and/or program logic which in combination with the computer system causes or programs computer system 1100 to be a special-purpose machine. According to one embodiment, the techniques herein are performed by computer system 1100 in response to processor 1104 executing one or more sequences of one or more instructions contained in main memory 1106. Such instructions may be read into main memory 1106 from another storage medium, such as storage device 1110. Execution of the sequences of instructions contained in main memory 1106 causes processor 1104 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 1110. Volatile media includes dynamic memory, such as main memory 1106. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1102. Transmission media can also take the form of acoustic or light waves, such as those generated during radio-wave and infra-red data communications.

Various forms of media may be involved in carrying one or more sequences of one or more instructions to processor 1104 for execution. For example, the instructions may initially be carried on a magnetic disk or solid state drive of a remote computer. The remote computer can load the instructions into its dynamic memory and send the instructions over a telephone line using a modem. A modem local to computer system 1100 can receive the data on the telephone line and use an infra-red transmitter to convert the data to an infra-red signal. An infra-red detector can receive the data carried in the infra-red signal and appropriate circuitry can place the data on bus 1102. Bus 1102 carries the data to main memory 1106, from which processor 1104 retrieves and executes the instructions. The instructions received by main memory 1106 may optionally be stored on storage device 1110 either before or after execution by processor 1104.

Computer system 1100 also includes a communication interface 1118 coupled to bus 1102. Communication interface 1118 provides a two-way data communication coupling to a network link 1120 that is connected to a local network 1122. For example, communication interface 1118 may be an integrated services digital network (ISDN) card, cable modem, satellite modem, or a modem to provide a data communication connection to a corresponding type of telephone line. As another example, communication interface 1118 may be a local area network (LAN) card to provide a data communication connection to a compatible LAN. Wireless links may also be implemented. In any such implementation, communication interface 1118 sends and receives electrical, electromagnetic or optical signals that carry digital data streams representing various types of information.

Network link 1120 typically provides data communication through one or more networks to other data devices. For example, network link 1120 may provide a connection through local network 1122 to a host computer 1124 or to data equipment operated by an Internet Service Provider (ISP) 1126. ISP 1126 in turn provides data communication services through the world wide packet data communication network now commonly referred to as the “Internet” 1128. Local network 1122 and Internet 1128 both use electrical, electromagnetic or optical signals that carry digital data streams. The signals through the various networks and the signals on network link 1120 and through communication interface 1118, which carry the digital data to and from computer system 1100, are example forms of transmission media.

Computer system 1100 can send messages and receive data, including program code, through the network(s), network link 1120 and communication interface 1118. In the Internet example, a server 1130 might transmit a requested code for an application program through Internet 1128, ISP 1126, local network 1122 and communication interface 1118.

The received code may be executed by processor 1104 as it is received, and/or stored in storage device 1110, or other non-volatile storage for later execution.

4. Extensions and Alternatives

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A data processing method, comprising:
storing data associated with one or more travel characteristics of an end user and a plurality of end user consumer events in a profile;
creating and storing a hotel marketability index score for each of one or more hotel properties using a weighted sum of one or more travel characteristics associated with one or more of the hotel properties, wherein the travel characteristics include hotel location within a cluster location, hotel quality within the cluster location and at least one of rate competitiveness and hotel availability;
modifying weights of the travel characteristics associated with one or more of the hotel properties according to an occurrence of one or more of the end user sorting hotels by proximity and at least one of rate, star ranking, and value;
ranking the hotel properties in an order based on the hotel marketability index;
wherein the method is performed using one or more computing devices.

2. An apparatus comprising:
one or more processors;
memory operatively coupled to the one or more processors and containing program instructions, wherein execution of the program instructions by the one or more processors causes the one or more processors to:
receive input to the one or more processors selection of a plurality of rating input characteristics associated with a hotel property, the plurality of rating input characteristics including hotel location and at least one of rate competitiveness, hotel availability, and hotel quality;
determine by the one or more processors a hotel marketability index score for the hotel property, the hotel marketability index score based on a weighted combination of the plurality of rating input characteristics associated with the hotel property; and
store the hotel marketability index score in association with a hotel property identifier of the hotel property in a memory.

3. The apparatus of claim 2, wherein execution of the program instructions by the one or more processors causes the one or more processors to identify a plurality of hotel properties, each identified hotel property being associated with a hotel property identifier stored in the memory; determine a cluster center based on geographic latitude and longitude coordinates; determine a cluster radius associated with the cluster center based on a population density associated with the cluster center; determine a hotel distance between a position of at least one of the plurality of hotel properties and the cluster center; associate the at least one of the plurality of hotel properties with the cluster center when the hotel distance is less than the cluster radius.

4. An apparatus comprising:
one or more processors;
memory operatively coupled to the one or more processors and storing instructions which, when executed by the one or more processors, causes the one or more processors to, in response to a consumer event:
assign a weight to each of one or more characteristics associated with a hotel property;
wherein the weight assigned to at least one characteristic of the one or more characteristics associated with the hotel property is based on the consumer event;
assign a hotel marketability index score to the hotel property, the hotel marketability index score being based on a combination of one or more weights assigned to the one or more characteristics associated with the hotel property.

5. The apparatus of claim 4, wherein the consumer event comprises any one of: search by general market; search by specific cluster; sort by rate; sort by star rating; sort by proximity; sort by value.

6. The apparatus of claim 4, wherein execution of the program instructions by the one or more processors causes the one or more processors to create an end user profile operable to store data associated with one or more travel characteristics of the end user and a plurality of end user consumer events; wherein the profile is coupled to a hotel marketability index that is operable to identify a plurality of hotel properties.

7. The apparatus of claim 4, wherein weights of the travel characteristics associated with one or more of the hotel properties vary according to an occurrence of one or more end user consumer events; wherein the travel characteristics associated with one or more of the hotel properties include hotel location within a cluster location, hotel quality within the cluster location, and at least one of rate competitiveness and hotel availability;
wherein execution of the program instructions by the one or more processors causes the one or more processors to determine a hotel result ordering, in response to a hotel search request by the end user, using a default hotel result ordering based on a default hotel marketability index; modify the determined hotel result ordering based on the one or more travel characteristics of the end user and the hotel marketability index.

8. A data processing method comprising:
receiving a search query that specifies at least a location;
using a stored database of items, based on the search query, determining an initial result set of items that satisfy the search query;
obtaining a plurality of property values for each item in the result set of items, including at least a number of bookings and a number of check-ins within a specified period, and including dynamically determining one or more of the property values at the time of the obtaining;
determining, for each item in the result set of items, a display rank value using a weighted sum of the plurality of property values for that item in combination with a plurality of stored coefficients for each of the property values;
ordering the result set of items based upon the display rank value of each of the items in the result set, to produce an ordered set of items;
causing generating one or more electronically displayable pages using the ordered set of items;
wherein the method is performed using one or more computing devices.

9. The method of claim 8 wherein the items are hotels.

10. The method of claim 8 wherein the plurality of property values comprise a look to book ratio.

11. The method of claim 8 wherein the plurality of property values comprise a look to book ratio determined as: Effective look for a property in a given time period=sum of [(1L*a page number coefficient/page number)+(1L*page position coefficient/position on page)]/number of impressions+sum of [1D*detail page coefficient]/number of detail page clicks, and wherein 1L denotes each impression on a listing page and 1D denotes one click through to a detail page for the item.

12. The method of claim 8 wherein the plurality of property values comprise a customer personal booking history value.

13. The method of claim 8 wherein the plurality of property values comprise a customer personal review value.

14. The method of claim 8 wherein the plurality of property values comprise a market rate.

15. The method of claim 8 wherein the plurality of property values comprise a user rating or reviews.

16. The method of claim 8 wherein the plurality of property values comprise one or more market-specific rules that specify including at least one particular item in the result set of items when the location is a particular location.

17. The method of claim 8 wherein the plurality of property values comprise one or more time-specific rules that specify including at least one particular item in the result set of items when the check-in date is a particular check-in date.

18. The method of claim 8 wherein the plurality of property values comprise historical prices.

19. A computer system comprising:
one or more processors;
one or more non-transitory computer-readable storage media coupled to the one or more processors, and storing one or more sequences of instructions which when executed using the one or more processors cause performing:
receiving a search query that specifies at least a location;
using a stored database of items, based on the search query, determining an initial result set of items that satisfy the search query;
obtaining a plurality of property values for each item in the result set of items, including at least a number of bookings and a number of check-ins within a specified period, and including dynamically determining one or more of the property values at the time of the obtaining;
determining, for each item in the result set of items, a display rank value using a weighted sum of the plurality of property values for that item in combination with a plurality of stored coefficients for each of the property values;
ordering the result set of items based upon the display rank value of each of the items in the result set, to produce an ordered set of items;
causing generating one or more electronically displayable pages using the ordered set of items.

20. The computer system of claim 19 wherein the items are hotels.
